(19) United States
(12) Patent Application Publication
(10) Pub. No.: US 2013/0108797 A1
(43) Pub. Date: May 2, 2013

(54) APPARATUS FOR APPLYING A LIQUID MATERIAL TO GLASS AND METHOD OF USING SAME

(71) Applicants: Matthew Rapin, Tecumseh, MI (US); David M. Kovach, Paris, KY (US); Douglas Burwell, Perrysburg, OH (US)

(72) Inventors: Matthew Rapin, Tecumseh, MI (US); David M. Kovach, Paris, KY (US); Douglas Burwell, Perrysburg, OH (US)

(73) Assignee: PILKINGTON GROUP LIMITED, NR. ORMSKIRK (GB)

(21) Appl. No.: 13/261,519

(22) PCT Filed: Jun. 14, 2011
(86) PCT No.: PCT/US2011/001072

§ 371 Date: Jan. 9, 2013

Related U.S. Application Data
(60) Provisional application No. 61/356,084, filed on Jun. 18, 2010.

(51) Int. Cl. B05D 1/40

(52) U.S. Cl. CPC B05D 1/40
USPC 427/429; 118/264

(57) ABSTRACT

An applicator is capable of being used manually, or as a component of an automated system, to simultaneously apply a liquid material, such as an adhesive or an adhesion-promoting primer, to a peripheral portion of a major surface of a vehicle window and to a corresponding portion of the substantially perpendicular edge of the vehicle window. A method of using the applicator is also provided.

### BACKGROUND OF INVENTION

The present invention relates to an apparatus for applying a liquid material to a predetermined peripheral portion of a glass substrate material.

More particularly, the present invention relates to an applicator capable of being used manually or as a component of an automated system to simultaneously apply a liquid adhesion-promoting primer material or the like to (1) a peripheral portion of a major surface of a vehicle window and (2) to a corresponding portion of the substantially perpendicular edge of the vehicle window.

For some years, it has been common to apply adhesives and adhesion-promoting materials, also known as primers, to peripheral portions of vehicle windows to facilitate bonding of, for example, a polymeric member to the portion of the vehicle window to which the adhesive and/or primer had previously been applied. As such efforts have tended to be labor-intensive and time-consuming, and thus costly, efforts have been undertaken to optimize such application processes, to decrease the amount of manual labor, thus decreasing cycle time and cost.

### SUMMARY OF THE INVENTION

The present invention relates to an apparatus for applying a liquid material to a predetermined peripheral portion of a glass substrate and a method of using the apparatus for application of the liquid material to the glass substrate.

More particularly, the present invention relates to an applicator capable of being used manually, or as a component of an automated system, to simultaneously apply a liquid adhesion-promoting primer material or the like to (1) a peripheral portion of a major surface of a vehicle window and (2) to a corresponding portion of the substantially perpendicular edge of the vehicle window.

The applicator of the invention is broadly “boot-shaped”, with the applicator surfaces having an “L” shape in profile. A connector removably attaches the applicator directly or indirectly to a source of liquid adhesion-promoting primer material or the like.

More specifically, in a preferred embodiment the applicator includes a base member, at least one wall member extending substantially perpendicularly from the base member to a predetermined height and in such a configuration that a portion of the base member extends beyond the at least one wall member for a predetermined distance creating the aforementioned “L” shape, and an opening in the at least one perpendicular wall member permitting the flow of the primer material or the like to a porous, fibrous, typically inorganic material disposed on the extended portion of the base member and on, or in, the at least one perpendicular wall member. This porous, fibrous material is commonly known as “felt.” The felt disposed on the extended portion of the base member may be the same as, or different from, the felt disposed on the perpendicular wall member. Upon being brought into contact with two surfaces, a controlled quantity of primer or the like is precisely transferred to, for example, the peripheral portion of a major surface of a vehicle window and, at the same time, to a corresponding portion of the substantially perpendicular edge of the vehicle window. Attached to the at least one perpendicular wall member at its upper extremity, the applicator has a connector having any suitable configuration to enable it to be attached, for example, directly to a container holding a quantity of primer material or the like, or to a robot arm and a tube through which primer material or the like can be transmitted to the applicator. Of course other means of conveying the primer material to the application or through the connector are possible.

A method of transferring, for example, an adhesive or adhesion-promoting primer to a vehicle window using the applicator of the invention is also an aspect of the invention.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 shows a semi-cross-sectional view of the applicator of the invention.

FIG. 2 shows a cross-sectional view of the “L” shaped applicator surfaces with felt and a glass substrate in priming orientation.

FIG. 3 is a perspective view of the apparatus used in a work station including an automated application system, according to the present invention.

### DETAILED DESCRIPTION OF THE INVENTION

The present invention relates to an apparatus for applying a liquid material to a predetermined peripheral portion of a glass substrate.

More particularly, the present invention relates to an applicator capable of being used manually, or as a component of an automated system, to simultaneously apply a liquid adhesion-promoting primer material or the like to (1) a peripheral portion of a major surface of a vehicle window and (2) to a corresponding portion of the substantially perpendicular edge of the vehicle window.

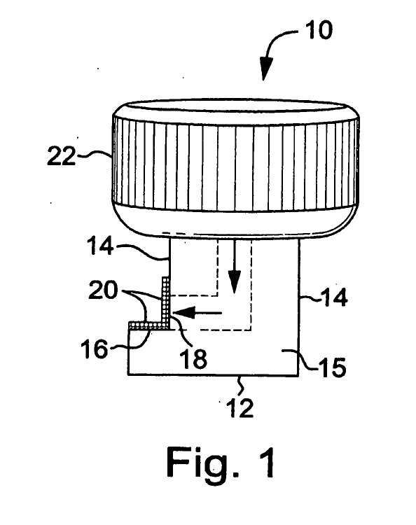

Referring to FIG. 1, the apparatus 10 of invention can be seen to include a base member 12 having any suitable shape, but that is preferably of rectangular and substantially planar configuration. Extending vertically to a predetermined height from the base member 12 at a position a predetermined distance from the periphery of the base member 12 is at least one perpendicular wall member 14. Other perpendicular wall members 15 preferably also extend vertically from the base member 12 a predetermined distance and are preferably positioned proximate a peripheral edge of the base member 12. The perpendicular wall members 14,15, are preferably permanently adhered to the base member 12, and to one or more adjacent wall members 14, 15, so as to form a volumetric space capable of containing an amount of liquid material in a liquid-tight manner, except as purposely configured to flow therethrough.

The at least one perpendicular wall member 14 positioned inboard from the peripheral edge of the base member 12 so as to form an extended base portion 16, also has at least one opening 18 formed therein to allow a liquid material to flow therethrough. In profile, the perpendicular wall member 14 and the extended base portion 16 form the shape of the upper case letter “L”. The at least one opening 18 is positioned so that normal gravitational forces will assist in causing the liquid material to flow through the at least one opening 18. Inserted in or proximate the at least one opening 18 in the at least one perpendicular wall member 14, so as to be in flowing communication therewith, is a predetermined quantity of a porous, fibrous material 20, known to those skilled in the art of liquid application as “felt”. Similarly, a predetermined quantity of “felt” 20 is adhered to the extended portion of the base member 16. Again, in profile, the area of felt 20 on the at least one perpendicular wall member 14, and the extended portion of the base member 16 form an upper case “L” shape. Typically, the fineness of the felt 20 is expressed in denier. The denier of the felt on/in the at least one perpendicular wall member and on the extended portion of the base member 16 may be the same or different.

Proximate the upper extremity of the at least one perpendicular wall member 14, and preferably proximate the respective upper extremities of the four perpendicular wall members 14, 15, and attached thereto by any suitable method, is a connector 22 to enable connection of the apparatus 10 to a source of a liquid material. The connector 22 can have any configuration necessary to provide a direct connection to, for example, a container such as a bottle which may be utilized in a manual fashion to transfer the liquid material to the glass substrate. Alternatively, the connector 22 may have a shape necessary to allow the apparatus 10 to be connected to an automated liquid application system including for example, a suitable electromechanical apparatus. The connector 22 may be fixedly or rotatably attached to the perpendicular wall members 14, 15. Movement of the liquid transfer surfaces of the apparatus of the invention may be in any of 1 to 3 axial directions, e.g., x, y and z.

The apparatus 10 of the invention may be fabricated from any suitable material, but is preferably made of a polymeric material. Especially suitable polymeric materials may include: nylon, polypropylene, and polyethylene.

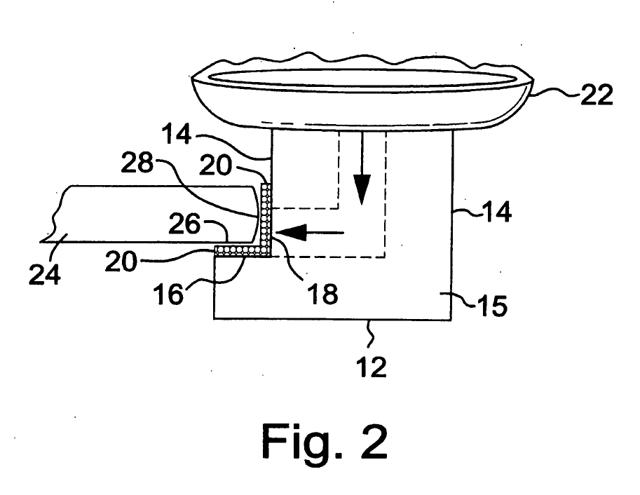

Referring now to FIG. 2, while the apparatus 10 of the invention may be utilized to transfer a variety of liquids to a substrate surface 24, its preferred use is to transfer adhesive material and/or adhesion-promoting primer materials to a glass substrate 24, such as a vehicle window. One of the unique capabilities of the apparatus 10 of the invention is its ability to simultaneously transfer such liquid material to a predetermined peripheral portion of a major surface 26 of the glass substrate 24 and to the substantially perpendicular peripheral edge portion 28 of the subject glass substrate 24 via the L-shaped profile of the felt 20 surfaces of the at least one perpendicular wall member 14 and the extended base member portion 16. Suitable adhesion-promoting primers may be clear or may have color, for example, a black or gray color.

The method of utilizing the apparatus 10 of the invention to transfer a liquid material to selected portions of, for example, a vehicle window will now be described.

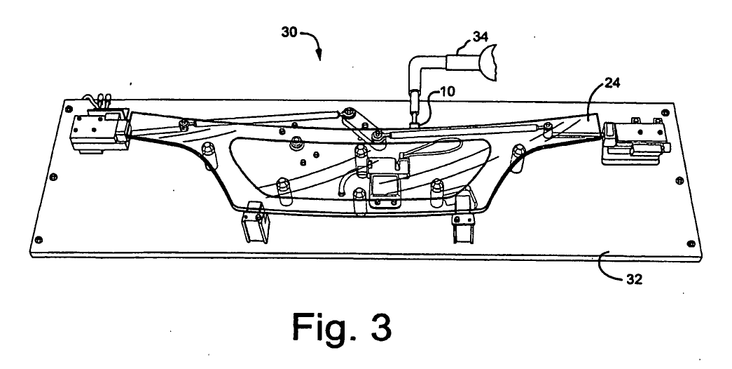

In a typical manufacturing operation, the apparatus 10 of the invention would be utilized in a work station/work cell 30 setting (see FIG. 3). In such a work station 30, a glass substrate 24, such as a vehicle window, may be positioned on a supporting member 32. Such supporting member 32 may be rotatable or fixed. If rotatable, the glass substrate 24 may be movable relative to an operator manually operating the apparatus 10 of the invention, or to an automated system having a stationary head proximate which the peripheral portion of the glass substrate 24 is moved, so as to uniformly transfer the liquid material to the desired portions of the periphery of the glass substrate 24.

If the support member 32 is fixed, it may be necessary for an operator grasping a container having the apparatus 10 of the invention attached thereto to move around the supported glass substrate 24, or an electro-mechanical apparatus 34 having a movable arm to move the apparatus 10 of the invention in a predetermined pattern corresponding to the shape of the periphery of the glass substrate 24.

In either a manual system or an automated system, the liquid material, such as an adhesive or an adhesion-promoting primer, is conveyed by a suitable means, e.g., gravity or a pumping mechanism from a source of the liquid material to the apparatus 10 of the invention where it is caused to flow through the apparatus 10, through the at least one opening 18 in the at least one perpendicular wall member 14 which is in flowing contact with the fibrous, porous “felt” 20 disposed in/proximate the at least one perpendicular wall member 14 and the felt 20 disposed on the extended portion of the base member 16. Preferably, the apparatus 10 of the invention is maintained in firm and continuous contact with the peripheral portions of the glass substrate 24, namely, a peripheral portion of a major surface 26 thereof, and the corresponding substantially perpendicular peripheral edge portion 28 of the glass substrate 24, to which the liquid material is being applied. This is desirable so as to maintain a continuous and uniform layer of liquid material on the desired surfaces. Correspondingly, it is desirable to maintain a uniform rate of movement between the glass substrate 24 and the apparatus 10, thereby to also enhance continuity and uniformity of application.

In this connection, one of the objectives of the invention is to decrease the time necessary to position the glass substrate 24, accomplish application of the liquid material to all of the desired portions of the substrate 24, remove the completed part from the support member 32, and ready another glass substrate 24 for processing, collectively also known as the “cycle time”. Comparing the cycle time in a manual mode utilizing known methods to the cycle time in a manual mode utilizing the present invention, the cycle times may be reduced from 60 sec.-90 sec. to 35 sec.-50 sec. Even more dramatic decreases in cycle time between the above-noted cycle times utilizing the invention in manual mode and in an automated mode can be achieved. Cycle times utilizing the invention in an automated mode between 15 sec. and 25 sec. are achievable with the invention.

The glass substrate 24 may be positioned on the supporting member 32 and removed therefrom manually or by electro-mechanical means, as well.

The apparatus 10 of the invention and method of using same may be applied to any vehicle window, for example, windshields, backlights, roof lights and the like.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed:

1. An apparatus for applying a liquid material to a peripheral portion of a glass substrate comprising:
a base member;
at least one wall member extending substantially perpendicularly to the base member for a predetermined distance, the at least one perpendicular wall member being positioned on the base member so that the base member extends beyond the at least one perpendicular wall member for a predetermined distance so as to form an “L” shaped profile;
the at least one perpendicular wall member having at least one opening formed therethrough to permit the passage of a liquid material;
a porous, fibrous material disposed proximate the at least one perpendicular wall member so as to be in flowing communication with the opening therein, and with liquid material flowing through the at least one opening;
a porous, fibrous material disposed on the extended portion of the base member and likewise in flowing communication with the liquid material flowing through the opening in the perpendicular wall member; and
a connector attached to the at least one perpendicular wall member for attaching the apparatus to a source of liquid material.

2. The apparatus for applying a liquid material defined in claim 1, wherein the one or more perpendicular wall members are adhesively bonded to the base member.

3. The apparatus for applying a liquid material defined in claim 2, wherein the one or more perpendicular wall members are adhesively bonded one to another.

4. The apparatus for applying a liquid material defined in claim 1, wherein the porous, fibrous material substantially fills the at least one opening in the at least one perpendicular wall member.

5. The apparatus for applying a liquid material defined in claim 1, wherein the porous, fibrous material substantially fills the at least one opening in the extended base portion.

6. The apparatus for applying a liquid material defined in claim 1, wherein the liquid material to be applied comprises an adhesive material.

7. The apparatus for applying a liquid material defined in claim 1, wherein the liquid material to be applied comprises an adhesion-promoting primer material.

8. The apparatus for applying a liquid material defined in claim 1, wherein the connector operatively connects the apparatus to a container containing a predetermined volume of liquid material which can be manually operated.

9. The apparatus for applying a liquid material defined in claim 1, wherein the connector operatively connects the apparatus to a dispensing system for an automated liquid application system.

10. The apparatus for applying a liquid material defined in claim 1, wherein the base member and the at least one perpendicular wall member comprise a polymeric material.

11. The apparatus for applying a liquid material defined in claim 10, wherein the connector comprises a polymeric material.

12. A method for utilizing an apparatus to apply a liquid material to a peripheral portion of a glass substrate comprising:
providing an apparatus comprising;
at least one wall member extending perpendicularly from the base member, at a location on the base member so that the base member extends beyond the at least one perpendicular wall member for a predetermined distance, thus forming an “L” shaped profile;
at least one opening formed in the at least one perpendicular wall member to permit the passage of a liquid material therethrough;
a porous, fibrous material disposed on at least a portion of each of the at least one perpendicular wall member and the extended portion of the base member, each such portion of the porous, fibrous material being in flowing communication with the liquid material flowing through the at least one opening;
a connector attached to the at least one perpendicular wall member proximate its upper extremity and also attaching the apparatus to a source of liquid material;
positioning a glass substrate in a precisely predetermined position on a supporting member;
causing a quantity of liquid material to move through the connector, through the at least one opening in the at least one perpendicular wall member and into flowing communication with the porous, fibrous material disposed on each of the at least one perpendicular wall member and the extended portion of the base member;
bringing a peripheral portion of a major surface of the glass substrate and the porous, fibrous material on the extended portion of the base member, and a corresponding peripheral portion of a substantially perpendicular edge of the glass substrate and the porous, fibrous material on the at least one perpendicular wall member, simultaneously into brushing contact, so as to transfer a predetermined amount of liquid material to a predetermined area of the major surface and substantially perpendicular edge of the glass substrate;
moving the glass substrate and the apparatus relative to each other while maintaining brushing contact between the apparatus and the glass substrate and maintaining the flow of liquid material through the porous, fibrous material so as to transfer same to the desired portions of the periphery of the glass substrate; and
removing the glass substrate from the support member.

13. The method of utilizing an apparatus to apply a liquid material defined in claim 12, wherein the application of the liquid material is an operation of a work station/work cell.

14. The method of utilizing an apparatus to apply a liquid material defined in claim 13, wherein the apparatus is stationary, and the glass substrate moves relative to the apparatus to provide for uniform application of the liquid material to the predetermined area of the major surface of the glass substrate and to the substantially perpendicular edge of the glass substrate.

15. The method of utilizing an apparatus to apply a liquid material defined in claim 13, wherein the apparatus moves relative to a stationary glass substrate to provide for a uniform application of the liquid material to the predetermined area of the major surface of the glass substrate and to the substantially perpendicular edge of the glass substrate.

16. The method of utilizing an apparatus to apply a liquid material defined in claim 12, wherein the cycle time for the liquid material application is between 35 sec. and 50 sec.

17. The method of utilizing an apparatus to apply a liquid material defined in claim 12, wherein the cycle time for the liquid material application is between 15 sec. and 25 sec.

18. The method of utilizing an apparatus to apply a liquid material defined in claim 12, wherein the glass substrate is a vehicle window.
